(19) United States
(12) Patent Application Publication
(10) Pub. No.: US 2009/0310272 A1
(43) Pub. Date: Dec. 17, 2009

(54) ENERGY SAVINGS AND SURGE PROTECTION DEVICE

(75) Inventor: William D. Howell, Eustis, FL (US)

Correspondence Address: EDWARD M. LIVINGSTON, PA, 963 TRAIL TERRACE DRIVE, NAPLES, FL, 34103, US

(73) Assignee: Global Energy Savings, Inc.

(21) Appl. No.: 12/140,391

(22) Filed: Jun. 17, 2008

(51) Int. Cl. H02H 3/22; G08B 5/00; G08B 23/00; H01G 5/00

(52) U.S. Cl. 361/111; 340/815.4; 340/500; 361/287

(57) ABSTRACT

An energy savings and surge protection devices device that saves electrical energy by optimizing the power factor in single-phase and three-phase applications through the use of capacitors (10) with fixed levels of capacitance and variable capacitance capacitors (13) while providing selectable periods of correction for periods of high or low energy demand through the use of on/off switches/buttons (6), timers (12), meters (17), and servo-loop controls (14) which are used to activate and deactivate capacitors (10) with fixed levels of capacitance and/or discreet capacitive cells (15) of variable capacitance capacitors (13). Additionally, surge protection is promoted through the use of surge arresters (11), also called metal oxide varistors (MOVs).

### BACKGROUND OF THE INVENTION

This invention relates to energy saving devices, more particularly, an energy savings device with surge protection which may provide selectable periods of correction to optimize reduction in energy usage over expected periods of high or low energy demand.

In residential or commercial establishments, the loads served by electric utility companies are generally primarily resistive, such as a space heater, or primarily inductive, such as a motor. The inductive loads draw a combination of kilowatts (real or inductive power) and kilovars (reactive power). Capacitors are a static source of kilovars.

Capacitors installed at inductive loads provide a number of benefits: reduced electrical energy consumption, reduced line current, increased voltage at the load, better voltage regulation and lower energy losses. These benefits are accomplished by installing sufficiently sized capacitors at the load to bring power factor to just under unity. Power factor is equal to killowatts divided by kilovars.

Unfortunately, capacitors are not used to optimize load factor as widely as they might be. This is especially true in residential and commercial applications. One reason for the latter is that current devices do not allow for any periods of correction to optimize reduction in energy usage over periods of high or low energy demand. Currently, energy saving devices use capacitors with fixed levels of capacitance, commonly measured in microfarads (mF). The size of a capacitor to be used in any residential or commercial application is determined by the average energy usage at the time of installation. However, this method of determining the required capacitance does not take into account periods of high or low energy demand. As a result, during periods of high energy demand, the capacitor may not be large enough to achieve the optimal reduction in kilowatt usage. Alternatively, during periods of low energy demand, the energy used to power the capacitor may offset any energy savings.

Thus, a need exists for an energy savings device which provides the user with selectable periods of correction to optimize reduction in energy usage over expected periods of high or low energy demand.

The relevant prior art includes the following references:

| Patent No. | | |
|---|---|---|
| _{(U.S. unless} | | Issue/ |
| _{stated otherwise)} | Inventor | Publication Date |
| 3,300,712 | Segsworth | 01/24/1967 |
| 3,859,564 | Zulaski | 01/07/1975 |
| 3,900,772 | Anderl, et al. | 08/19/1975 |
| 5,138,519 | Stockman | 08/11/1992 |
| 5,227,962 | Marsh | 07/13/1993 |
| 5,287,288 | Brennen, et al. | 02/15/1994 |
| 5,510,689 | Lipo, et al. | 04/23/1996 |
| 5,627,737 | Maekawa, et al. | 05/06/1997 |
| 5,638,265 | Gabor | 06/10/1997 |
| 5,793,623 | Kawashima, et al. | 08/11/1998 |
| 5,878,584 | Sasaki, et al. | 03/09/1999 |
| 6,008,548 | Fenner, et al. | 12/28/1999 |
| 6,191,676 | Gabor | 02/20/2001 |
| 2002/0089373 | Shashoua | 07/11/2002 |
| 6,462,492 | Sakamoto, et al. | 10/08/2002 |
| 6,573,691 | Ma, et al. | 06/03/2003 |
| 6,747,373 | Hu, et al. | 06/08/2004 |
| 6,876,178 | Wu, et al. | 04/05/2005 |
| 7,092,232 | Yamagata, et al. | 08/15/2006 |
| 7,203,053 | Stockman | 05/10/2007 |

### SUMMARY OF THE INVENTION

The primary objects of the present invention are to provide an energy savings and surge protection device that:

optimizes power factor;

reduces kilowatt usage;

provides surge protection;

provides brown-out protection;

optimizes reduction in energy usage over expected periods of high or low energy demand; and

extends the life span of motors and appliances.

The present invention fulfills the above and other objects by providing a device that saves electrical energy by optimizing the power factor through the use of capacitors and provides selectable periods of correction for periods of high or low energy demand through the use of on/off switches, timers, meters, servo-loop control systems and variable capacitance capacitors. Additionally, surge protection is promoted through the use of surge arresters, also called metal oxide varistors (MOVs).

Power factor optimization is a technique used to improve the relationship between inductive power and reactive power as follows:

$$power factor ( pf ) = \frac{kilowatts ( working / real / inductive power )}{kilovars ( apparent / total reactive power )}$$

As is typical of energy saving devices, the present device uses capacitors, however, unlike prior devices, the present device uses capacitors in which the capacitance can be varied depending on the amount of power factor correction that is needed. Capacitors are static sources of kilovars or reactive power and can be installed at a circuit breaker box or switch of inductive equipment, such as air conditioner motors, to reduce amperage usage and adjust the power factor as close as possible to unity, i.e., 1. In this manner the equipment is provided only the power necessary to operate optimally. In addition to reducing electrical usage, the device also provides surge, lightning, and brown-out protection through the use of surge arresters.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front perspective exterior view of an energy savings and surge protection device of the present invention;

FIG. 2 is a front perspective interior view of an energy savings and surge protection device of the present invention for use in single-phase applications;

FIG. 3 is a front perspective interior view of an energy savings and surge protection device of the present invention for use in three-phase applications;

FIG. 4 is a front perspective interior view of an energy savings and surge protection device of the present invention having a variable capacitance capacitor for use in single-phase applications;

FIG. 5 is a front perspective interior view of an energy savings and surge protection device of the present invention having a variable capacitance capacitor for use in three-phase applications;

FIG. 6 is a wiring diagram of an energy savings and surge protection device of the present invention;

FIG. 7 is a front perspective view of a variable capacitance capacitor used in the energy savings device of the present invention having an on/off switchable capacitor;

FIG. 8 is an interior view of a variable capacitance capacitor used in the energy savings device of the present invention;

FIG. 9 is a front perspective interior view of an energy savings and surge protection device of the present invention with timer for use in single-phase applications;

FIG. 10 is a front perspective interior view of an energy savings and surge protection device of the present invention with timer for use in three-phase applications; and

FIG. 11 is a front perspective exterior view of an energy savings and surge protection device of the present invention having a meter.

### DESCRIPTION OF THE PREFERRED EMBODIMENTS

For purposes of describing the preferred embodiment, the terminology used in reference to the numbered components in the drawings is as follows:

1. unit

2. outer enclosure

3. front cover

4. inner cover

5. knockout hole

6. on/off switches/buttons

7. capacitor on/off indicator lamp

8. power indicator lamp

9. hazard indicator lamp

10. capacitor

11. surge arresters

12. timer

13. variable capacitance capacitor

14. servo-loop control

15. discreet capacitive cell

16. tap

17. common terminal

18. meter

19. capacitance indicator lamp

20. screws

21. activation switches

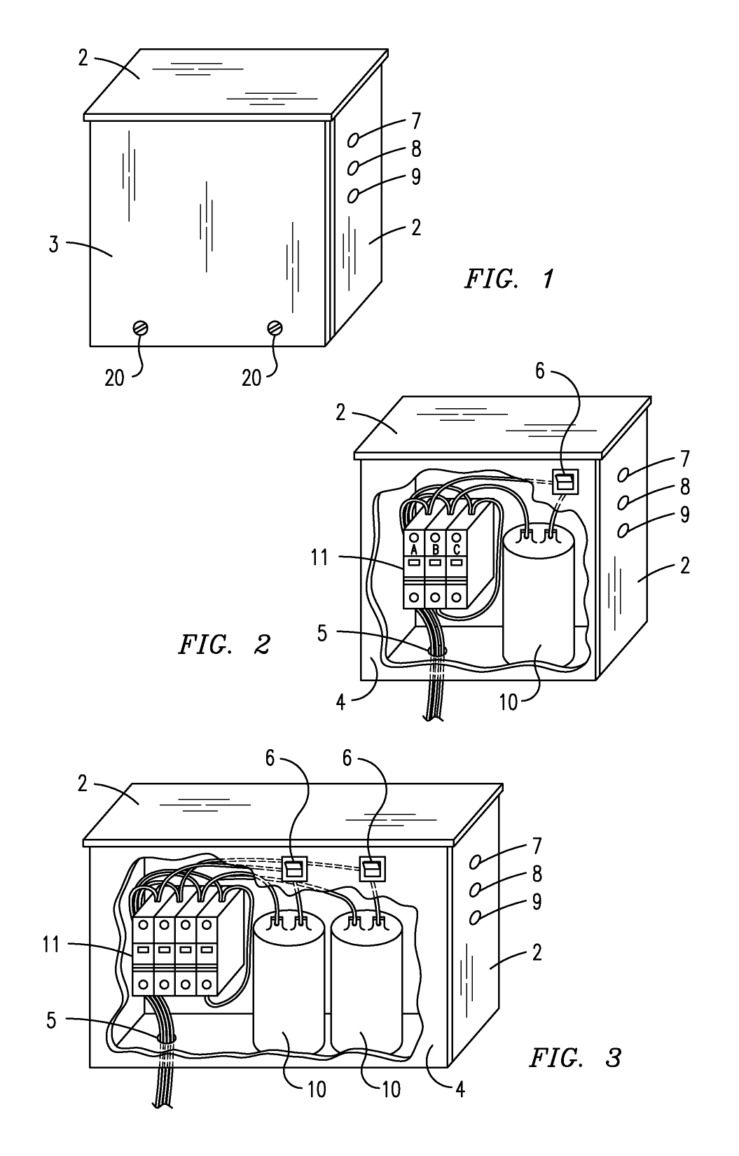

As shown in FIGS. 1, 2 and 3, a preferred embodiment of the present invention is a unit 1, made up of an outer enclosure 2 having a removable front cover 3, an inner cover 4 and knockout holes 5 for connection to an electrical service, preferably a circuit breaker switch or switch at an electrical panel or meter. Upon installation the front cover 3 may be secured to the outer enclosure 2 using screws 20, rivets, etc. to prevent unapproved access to the unit. Surge arresters 11 located inside the outer enclosure 2 provide surge, lightning, and brown-out protection by consistently supplying appropriate voltage load. The number of surge arresters 11 depend on the electrical demand of an application. At least one capacitor 10 is located inside of the outer enclosure 2. The number and capacitance level measured in microfarads of the capacitors 10 in the unit 1 depend on the electrical demand of an application and if the application is a single-phase or three-phase application. At least one on/off switches/button 6 may be for manually activating and deactivating the at least one capacitor 10 during periods of high or low energy consumption is located on the inner cover 4 of the outer enclosure 2. When a unit 1 has more than one capacitor, as shown in FIG. 3, multiple on/off switches/buttons 6 may be used for individually activating and deactivating the capacitors 10 to achieve various capacitance levels.

Three indicator lamps may be located on the front cover 3. A capacitor on/off indicator lamp 7 indicates whether the capacitors 10 are activated or deactivated, a power indicator lamp 8, preferably amber, indicates that electricity is being supplied to the unit 1, and a hazard indicator lamp 9, preferably red, indicates if the unit 1 is not functioning properly. The unit 1 may be connected to an electrical service at the breaker box in any single phase or three phase service.

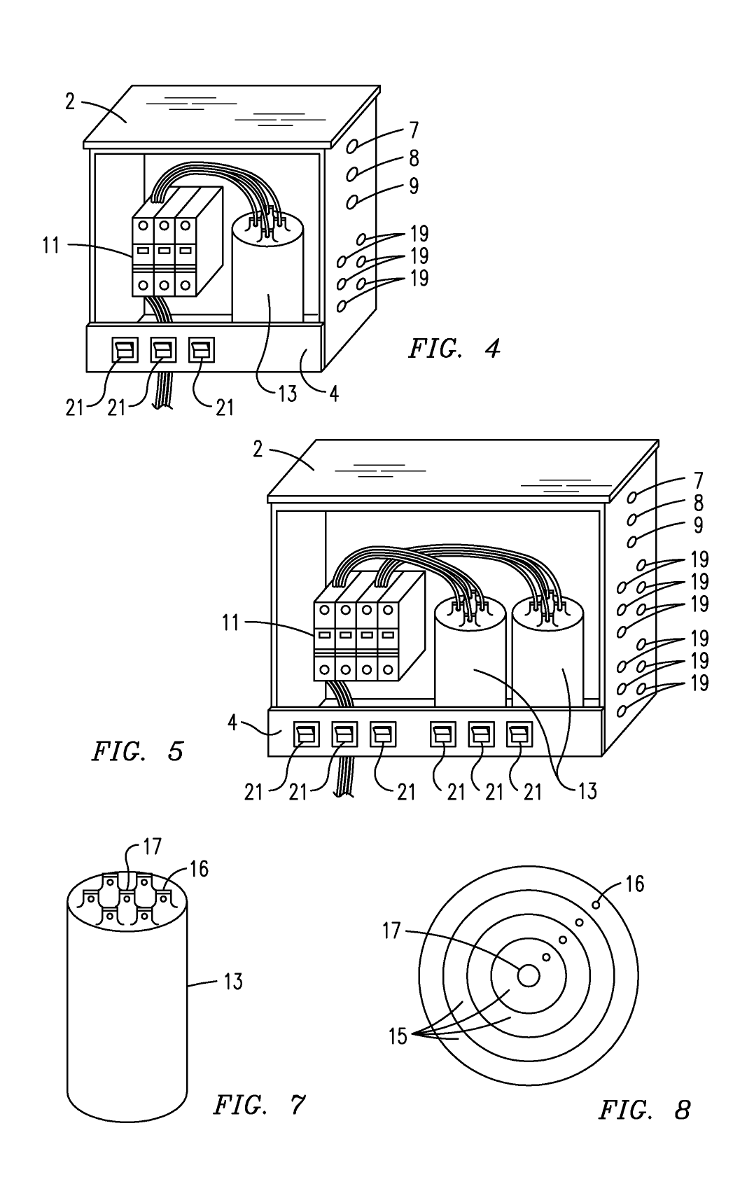

Referring now to FIGS. 4 and 5, a second embodiment of the invention is shown in which the unit 1 uses at least one variable capacitance capacitor 13 in place of a standard capacitor 10 having a fixed level of capacitance. The number of variable capacitance capacitors 13 in the unit 1 depend on the electrical demand of an application and if the application is a single-phase or three-phase application.

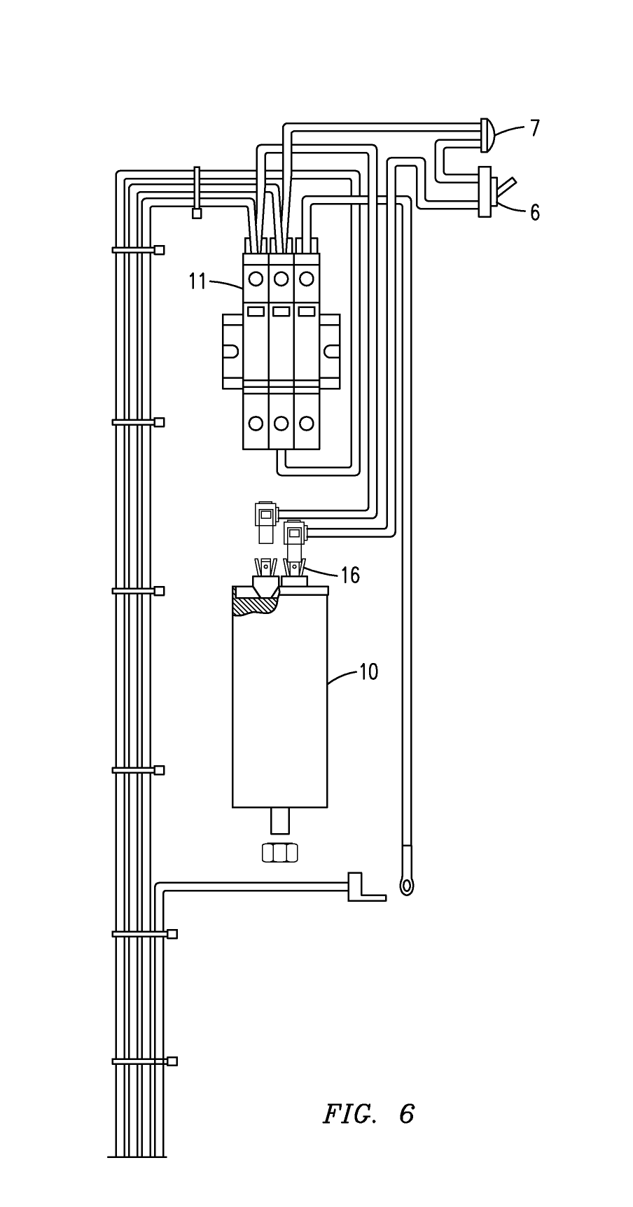

FIG. 6 shows a wiring diagram of the invention having a single capacitance capacitor 10 with taps 16 electrically connected to a bank of surge arresters 11 with an on/off switch 6 and a capacitor on/off indicator light 7.

As further shown in FIGS. 7 and 8, the variable capacitance capacitor 13 is made up of multiple discreet capacitive cells 15 separated from each other and having individual taps 16 or a common terminal 17. Each discreet capacitive cell 15 has a fixed capacitance level. The individual taps 16 allow the user to individually activate and deactivate each discreet capacitive cell 15 through the use of activator switches/buttons 21, timers 12 and/or meters 18 to achieve various levels of capacitance without the use of multiple standard capacitors with fixed levels of capacitance. For example, as shown in FIG. 4, a single-phase unit 1 having a variable capacitance capacitor 13 with three multiple discreet capacitive cells 15, one discreet capacitive cell 15 having a capacitance level of twenty microfarads, a second discreet capacitive cell 15 having a capacitance level of forty microfarads and a third discreet capacitive cell 15 having a capacitance level of forty microfarads, maybe set using the three activator switches/buttons 21, located on the inner cover 4, to capacitance levels of twenty microfarads, forty microfarads, sixty microfarads, eighty microfarads, or one-hundred microfarads. Alternatively, the multiple discreet capacitive cells 15 may all be deactivated at the same time when no power correction is needed. The level of capacitance may be displayed on the outside of the unit with the use of capacitance indicator lamps 19. The discreet capacitive cells 15 may also be controlled through the use of a servo-loop control 14 which actively monitors power consumption and automatically activates or deactivates discreet capacitive cells 15 so as to change the level of capacitance according to the energy demand at any given time.

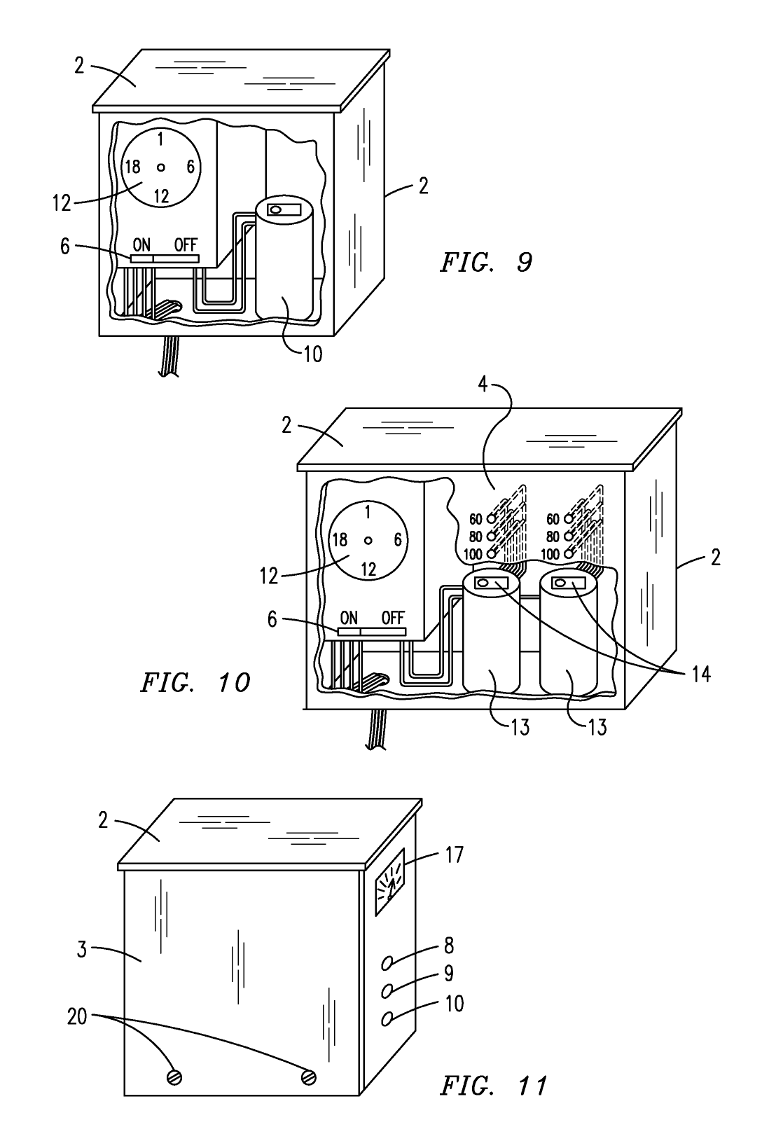

Referring now to FIG. 9, a third embodiment is illustrated in which a timer 12 located inside the outer enclosure 2, provides the option of programing the unit 1 with multiple start and stop times for activating and deactivating the capacitor 10 depending on periods of high or low energy demands. For example, in a commercial setting, the timer 12 may be programmed to activate the capacitor 9 during a business' hours of operation when there is a high energy demand and programmed to deactivate the capacitor 10 while the business is closed and when there is a low energy demand.

In addition, as shown in FIG. 10, the timer 12 may be programmed to individually activate and deactivate multiple capacitors 10 or multiple discreet capacitive cells 15 of variable capacitance capacitor 13 to achieve various capacitance levels at different times.

As shown in FIG. 11, a forth embodiment of the invention uses a meter 18 to measure energy usage and automatically activates and deactivates the capacitor 10 or multiple discreet capacitive cells 15 of variable capacitance capacitor 13 to achieve various capacitance levels depending on the energy demand at any given time.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. An energy savings and surge protection device comprising:
an enclosure;
at least one capacitor; and
at least one on/off switch/button for activating and deactivating the at least one capacitor.

2. The energy savings and surge protection device of claim 1 further comprising:
at least one capacitor indicator light to indicate if the at least one capacitor is activated or deactivated.

3. The energy savings and surge protection device of claim 1 further comprising:
a power indicator light to indicate if electricity is being conducted through the energy savings and surge protection device.

4. The energy savings and surge protection device of claim 2 further comprising:
a power indicator light to indicate if electricity is being conducted through the energy savings and surge protection device.

5. The energy savings and surge protection device of claim 1 further comprising:
a hazard indicator light to indicate a problem with the energy savings and surge protection device.

6. The energy savings and surge protection device of claim 2 further comprising:
a hazard indicator light to indicate a problem with the energy savings and surge protection device.

7. The energy savings and surge protection device of claim 3 further comprising:
a hazard indicator light to indicate a problem with the energy savings and surge protection device.

8. The energy savings and surge protection device of claim 1 further comprising:
at least one surge arrester.

9. The energy savings and surge protection device of claim 1 further comprising:
at least one timer for activating and deactivating the at least one capacitor.

10. The energy savings and surge protection device of claim 1 further comprising:
a meter which measures kilowatt usage and automatically activates or deactivates the at least one capacitor depending on the energy demand.

11. The energy savings and surge protection device of claim 1 further comprising:
at least one capacitance indicator lamp to indicate the level of capacitance.

12. The energy savings and surge protection device of claim 1 further comprising:
a meter to indicate the level of capacitance.

13. An energy savings and surge protection device of claim 1 wherein:
the at least one capacitor is at least one variable capacitance capacitor;
said at least one variable capacitance capacitor having multiple discreet capacitive cells;
said discreet capacitive cells having individual capacitance levels;
said multiple discreet capacitive cells each having an individual terminal; and
said multiple discreet capacitive cells all having a common terminal.

14. The energy savings and surge protection device of claim 13 further comprising:
at least one on/off switch/button to individually activate and deactivate said multiple discreet capacitive cells.

15. The energy savings and surge protection device of claim 13 further comprising:
a capacitor indicator light to indicate if the at least one variable capacitance capacitor is activated or deactivated.

16. The energy savings and surge protection device of claim 13 further comprising:
a power indicator light to indicate if electricity is being conducted through the energy savings and surge protection device.

17. The energy savings and surge protection device of claim 13 further comprising:
a hazard indicator light to indicate a problem with the energy savings and surge protection device.

18. The energy savings and surge protection device of claim 13 further comprising:
at least one surge arrester.

19. The energy savings and surge protection device of claim 13 further comprising:
at least one timer for activating and deactivating said multiple discreet capacitive cells.

20. The energy savings and surge protection device of claim 13 further comprising:
a meter which actively measures kilowatt usage and individually activates or deactivates said multiple discreet capacitive cells depending on the energy demand.

21. The energy savings and surge protection device of claim 13 further comprising:
at least one servo-loop control system.

22. The energy savings and surge protection device of claim 13 further comprising:
multiple capacitance lamps to indicate if said multiple discreet capacitive cells are activated or deactivated.

23. The energy savings and surge protection device of claim 13 further comprising:
a meter to indicate the level of capacitance of said at least one variable capacitance capacitor.

24. A variable capacitance capacitor comprising:
multiple discreet capacitive cells;
said discreet capacitive cells having individual capacitance levels;
said multiple discreet capacitive cells each having an individual terminal;
said multiple discreet capacitive cells all having a common terminal; and
a servo-loop control system to automatically activate various discreet capacitive cells as needed.
